(19) United States
(12) Patent Application Publication
(10) Pub. No.: US 2024/0219648 A1
(43) Pub. Date: Jul. 4, 2024

(54) FIBER OPTIC CONNECTORS HAVING A SEALING GASKET DISPOSED ON THE FERRULE ASSEMBLY

(71) Applicant: Corning Research & Development Corporation, Corning, NY (US)

(72) Inventor: Thomas Theuerkorn, Hickory, NC (US)

(21) Appl. No.: 18/604,860

(22) Filed: Mar. 14, 2024

Related U.S. Application Data
(63) Continuation of application No. PCT/US2022/044997, filed on Sep. 28, 2022.
(60) Provisional application No. 63/249,855, filed on Sep. 29, 2021.

(51) Int. Cl. G02B 6/38; G02B 6/40

(52) U.S. Cl. CPC G02B 6/3847; G02B 6/3853; G02B 6/406

(57) ABSTRACT

Fiber optic connectors having a sealing gasket disposed on a portion of the ferrule assembly and methods of making the same for inhibiting moisture, dirt, debris or dust from reaching a ferrule end face when the connector is mated are disclosed. The ferrule assembly of the fiber optic connector may be configured for physical contact or a lens-based optical transmission. When assembled, the fiber optic connectors have the sealing gasket disposed within a passageway of the connector housing for providing an internal sealing cavity within the passageway of the fiber optic connectors when mated, thereby providing environmental protection within the passageway of the connector housing that houses the optical interface. The connector concepts also allow quick and easy manufacture and assembly of the connector in a reliable, modular and configurable connector package.

### CROSS-REFERENCES TO RELATED APPLICATIONS

This application is a continuation of International Application No. PCT/US2022/044997, filed on Sep. 28, 2022, which claims the benefit of priority to U.S. Application No. 63/249,855, filed on Sep. 29, 2021, both applications being incorporated herein by reference.

### FIELD

The disclosure is directed to fiber optic connectors having a sealing gasket disposed on a ferrule assembly for inhibiting moisture, dirt, debris or dust from reaching the optical interface such as a ferrule end face of lens when the fiber optic connector is mated.

### BACKGROUND

Optical fiber is increasingly being used for a variety of applications, including but not limited to broadband voice, video, and data transmission in a variety of new and expanding applications. As bandwidth demands increase optical fiber is migrating deeper into these new communication networks such as fiber inside the premises applications, in-vehicle optical networks and the like. As optical fiber extends deeper into these communication networks there exist a need for quickly and easily making optical connections in a quick and easy manner while meeting the demands for these emerging applications.

Fiber optic connectors were developed for making one or more plug and play optical connections using a suitable fiber optic connector for the given application. Fiber optic connectors provide a node for mating and unmating in the optical network and provide the flexibility of locating the connection points in convenient locations for efficient network assembly, access, design and/or deployment. Conventional fiber optic connectors used for telecommunications, are used indoors or inside enclosures for inhibiting moisture, dust, dirt or debris or the like from reaching the mating interface of the fiber optic connector. Hardened fiber optic connectors were developed for outdoor applications that for inhibiting moisture, dust, dirt or debris or the like from reaching the mating interface of the fiber optic connector. However, these hardened fiber optic connectors are relatively large, bulky and/or expensive.

As new applications emerge for the deployment of optical networks the requirements for these new applications may be different and/or have other considerations for the given application. One such emerging application is the use of optical systems on vehicles that present a new environment with specific challenges for successful deployment in a harsh environment while requiring a relatively compact footprint in a robust and reliable package while enabling serviceability, case of manufacture and the like. Consequently, there exists an unresolved need for robust fiber optic connectors that preserve optical performance and protect the optical mating interface of fiber optic connector when mated for use in these new and emerging applications while also providing a compact footprint for the optical connection.

### SUMMARY

The disclosure is directed to fiber optic connectors that protect the optical interface robust, compact and reliable package while enabling serviceability, case of manufacture and the like.

One aspect of the disclosure is directed to fiber optic connectors comprising at least one ferrule assembly, an optical fiber, a connector housing and a sealing gasket. The ferrule assembly comprises a both extending from a rear end into the ferrule assembly with an optical interface disposed at the front end of the ferrule assembly. An optical fiber is disposed within the bore of the ferrule assembly. The connector housing comprises a passageway extending from a rear end to a front end, and the ferrule assembly is at least partially disposed with the passageway. The sealing gasket is disposed about a portion of the ferrule assembly for inhibiting contaminants from reaching the optical interface of the ferrule assembly when the connector is mated.

Another aspect of the disclosure is directed to fiber optic connectors comprising a ferrule, a ferrule holder, an optical fiber, a connector housing and a scaling gasket. The ferrule comprises a both extending from a rear end into the ferrule with an optical interface disposed at the front end of the ferrule. The ferrule holder comprises a forward portion and a rearward portion with a shoulder disposed between the forward portion and the rearward portion where the ferrule is attached to the ferrule holder to form a ferrule assembly. An optical fiber is disposed within the bore of the ferrule. The connector housing comprises a passageway extending from a rear end to a front end, and the ferrule assembly is at least partially disposed with the passageway. The sealing gasket is disposed about a portion of the ferrule assembly for inhibiting contaminants from reaching the optical interface of the ferrule assembly when the connector is mated.

The disclosure is also directed to a method of making a fiber optic connector comprising assembling a ferrule into a ferrule holder to form a ferrule assembly where the ferrule comprises a bore extending from a rear end into the ferrule, and an optical interface disposed at a front end of the ferrule. The method includes positioning a scaling gasket about a portion of the ferrule assembly for inhibiting contaminants from reaching the optical interface of the ferrule when the fiber optic connector is mated. The ferrule assembly is inserted into a passageway of a connector housing that extends from a rear end to a front end of the connector assembly so that the ferrule assembly is at least partially disposed within the passageway, and placing an optical fiber within the bore of the ferrule.

The ferrule assembly of the fiber optic connector may be configured for physical contact or a lens-based optical transmission as desired. When assembled, the fiber optic connectors have the sealing gasket disposed within a passageway of the connector housing for providing an internal sealing cavity within the passageway of the fiber optic connectors when mated, thereby providing environmental protection within the passageway of the connector housing that houses the optical interface. The connector concepts also allow quick and easy manufacture and assembly of the connector in a reliable, modular and configurable connector package. Additionally, the fiber optic connectors disclosed may be a portion of a cable assembly used in a vehicle.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 is a top perspective view of an optical mating of cable assemblies having explanatory fiber optic connectors configured as a male plug that is mated to a fiber optic connector configured as a female receptacle with the ferrule assemblies of the respective fiber optic connectors have a sealing gasket disposed about a portion of the ferrule assemblies disposed within the respective connector housings of the fiber optic connectors;

FIG. 2 is a bottom perspective sectional view of the optical mating of the explanatory fiber optic connectors of FIG. 1 taken through the ferrule assemblies and showing the construction of the fiber optic connectors with the respective sealing gaskets disposed about a portion of the ferrule assemblies;

FIG. 3 is a side sectional view of another optical mating similar to the explanatory fiber optic connectors of FIG. 1 taken through the ferrule assemblies showing the fiber optic connectors with the respective sealing gaskets disposed about a portion of the ferrule assemblies along with optional secondary sealing disposed rearward of the sealing gaskets;

FIG. 4 is partial perspective sectional view of a representative optical mating of explanatory fiber optic connectors similar to FIG. 1 showing the sealing cavity formed within a passageway connector housing of the fiber optical connector configured as the receptacle;

FIG. 5 is a partial perspective sectional view of the connector housing of the fiber optic connector configured as the male plug showing the terminated ferrule assembly with the sealing gasket being inserted into a passageway of the connector housing;

FIG. 6 is a partial perspective sectional view of the connector housing of the fiber optic connector configured as the male plug showing the terminated ferrule assembly with the sealing gasket and a dust cap being inserted into a passageway of the connector housing;

FIG. 7 depicts another configuration of fiber optic connectors configured as a male plug and female receptacle having respective ferrule assemblies with a sealing gasket where the ferrule assemblies comprising an optical interface having lenses; and

FIG. 8 depicts the fiber optic connectors similar to the fiber optic connectors of FIG. 7 in a mated state and shown with transparent housings.

### DETAILED DESCRIPTION

Reference will now be made in detail to the embodiments of the disclosure, examples of which are illustrated in the accompanying drawings. Whenever possible, like reference numbers will be used to refer to like components or parts.

The concepts disclosed are related to fiber optic connectors suitable for use in applications that may be exposed to the environment such as moisture, dirt, dust, debris or the like. Suitable applications may include vehicles having on-board optical systems like automotive applications, trucks, motorcycles, aerospace, farm equipment, ships or the like, but other applications are possible for concepts disclosed. The fiber optic connectors disclosed comprise a sealing gasket disposed about a portion of a ferrule assembly for inhibiting contaminants from reaching the optical interface of the ferrule assembly when the fiber optic connector is mated with a suitable device. The mating interfaces of fiber optic connectors may be impacted by moisture, dust, dirt and debris that can cause undue optical attenuation and the present concepts preserve optical performance for emerging applications that may desire to use optical communication networks. The fiber optic connectors (hereinafter “connectors”) disclosed may be configured as a male plug, a receptacle, a port on a device or the like.

The connectors comprise one or more sealing gaskets as separate components that may be disposed on the ferrule assembly so that the sealing gasket provides environmental protection when the connector is mated with a suitable device such as a complimentary connector, transceiver or other suitable device. When assembled, the sealing gasket is disposed within a passageway of the connector housing, and should not be confused with seals disposed on the outer surface of the connector housing. Instead, locating the sealing gasket on the ferrule assembly within the connector housing provides an internal sealing cavity for the optical mating within the passageway of the connector housing, thereby providing environmental protection when connector is in the mated state. The connector concepts also allow quick and easy manufacture and assembly of the connector in a reliable, modular and configurable connector package. Further, the concepts may be used with ferrule assemblies that have an optical interface that uses physical contact between optical fibers or using lenses for optical mating as desired. As used herein, the term “ferrule assembly” may comprise a single component or multiple components. By way of example, the ferrule assembly could be formed as a single component if desired or formed from multiple components.

Still further, the concepts disclosed may be used with any suitable fiber optic connector configuration such a male plug connector, a female receptacle connector or a connector configured as a connector port on a device. Generally speaking, the fiber optic connectors disclosed provide an internal sealing feature for the optical mating interface of the connector for preserving optical performance and allowing use of the connectors in demanding applications such as vehicle applications or the like and the connectors may be mated and unmated if needed, thereby advantageously providing a connector that may be unplugged and reconnected as needed for service or the like. The connector concepts may also be used in larger wiring harnesses such as constructing sub-assemblies for future installation in the manufacturing process for vehicles or the like at the appropriate time during the manufacturing process.

Of course, the concepts disclosed may be used in other applications such as in-home networks or the like. For instance, the concepts disclosed herein may also be suitable for fiber optic networks such as for Fiber-to-the-location (FTTx) and 5G applications, and are equally applicable to other optical applications as well including indoor, industrial, wireless, or other suitable applications. Additionally, the concepts disclosed may be used with fiber optic connectors having any suitable footprint, configuration or construction. Reference to “forward”, “front”, “rearward” and “rear” as used herein are relative terms that generally relate to the orientation of the fiber optic connector where the front or forward portion is with respect to the direction of the mating end of the fiber optic connector or component(s) and the rear or rearward portion is with respect to the direction of the portion of the fiber optic connector where the fiber optic cable is first inserted into the fiber optic connector or component(s). Various components or structures are described in this disclosure as being forward or rearward relative to one another. Various designs, constructions, or features for fiber optic connectors are disclosed in more detail with respect to explanatory embodiments as discussed herein and may be modified or varied as desired.

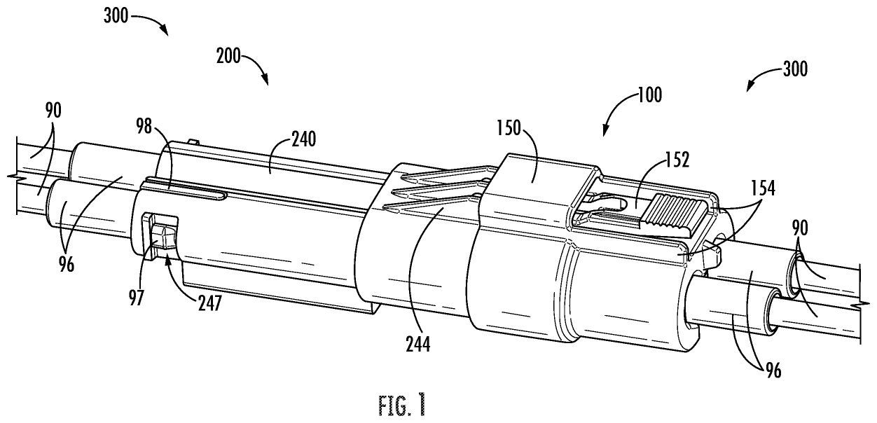

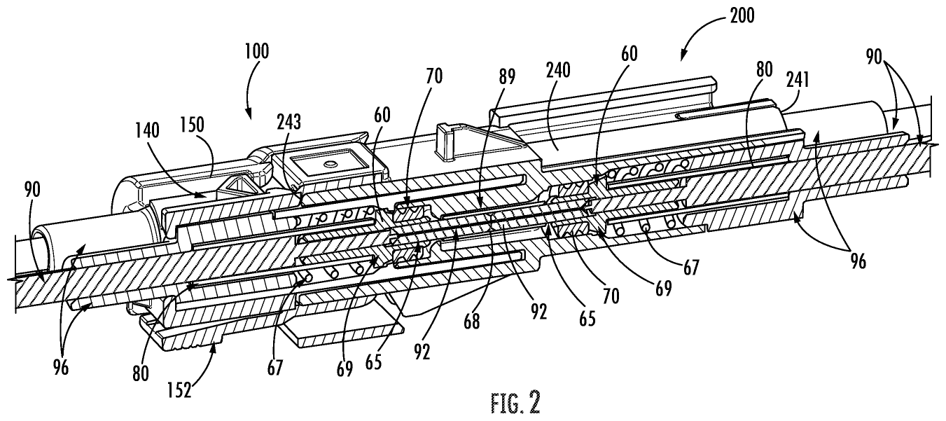

FIG. 1 is a top perspective view of an optical mating of a first cable assembly 300 to a second cable assembly 300 with explanatory connectors as shown. The first cable assembly 300 on the right-side is terminated to one or more fiber optic cable(s) 90 with a connector 100 configured as a male plug that is optically mated to second cable assembly 300 on the left-side and is terminated to fiber optic cable(s) 90 with a connector 200 configured as a female receptacle. FIG. 2 is a bottom perspective sectional view of the optical mating of connectors 100, 200 of FIG. 1 taken through the respective ferrule assemblies 60 of connectors 100, 200 with the connectors on different sides from FIG. 1.

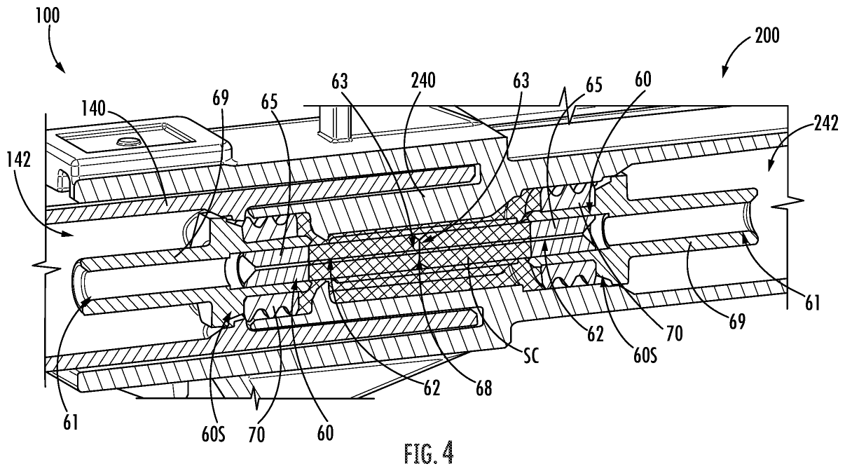

Disclosed connectors 100, 200 comprise at least one ferrule assembly 60 for optical mating, but may have any suitable number of ferrule assemblies. Ferrule assembly 60 comprises a bore 62 extending from a rear end 61 into the ferrule assembly 60 along with an optical interface 68 disposed at the front end of the ferrule assembly 60. An optical fiber 92 may be disposed within the bore 62 of the ferrule assembly. A sealing gasket 70 is disposed about a portion of the ferrule assembly 60 for inhibiting contaminants from reaching the optical interface 68 of the ferrule assembly 60 when the connector 100, 200 is mated. Each connectors 100, 200 comprises a respective connector housing 140, 240. Connector housing 140, 240 each comprise a respective passageway 142, 242 extending from a respective rear end 141, 242 to a respective front end 143, 243 of the connector housing 140, 240, and the respective ferrule assembly 60 is at least partially disposed within the respective passageway 142, 242. As depicted, sealing gasket 70 is disposed within the respective passageway(s) 142, 242 of the connector housing 140, 240 of each connector 100.200. Thus, mated connectors according to the concepts disclosed may create a sealing cavity (SC) within the passageway of the connector housing(s) such as depicted in FIG. 4. The disclosed concepts provide a robust and reliable connector in a compact package that is quick and easy to assemble, manufacture, disconnect and reconnect as needed.

As shown in FIGS. 1 and 2, connectors 100, 200 are duplex connectors with each connector 100, 200 having two ferrule assemblies 60 that are at least partially disposed within the respective connector housings 140, 240, but the concepts may be used with any suitable number of ferrule assemblies. The duplex connectors may use connector housings 140, 240 having furcated passageways 142, 242 (i.e., a first passageway and a second passageway) aligned side-by-side for receiving respective ferrule assemblies 60 as depicted. Duplex connectors comprise a second ferrule assembly 60 comprising a second sealing gasket 70 disposed on the second ferrule assembly 60 like the first ferrule assembly, thereby providing the sealing gasket 70 within the respective passageway.

Connectors according to the concepts disclosed may also support ferrule assemblies 60 with optical mating using physical contact between optical fibers or free-space transmission using lens as desired. Connectors 100, 200 comprise ferrule assemblies 60 that may terminate any suitable fiber optic cable 90 as desired. Fiber optic cable 90 includes at least optical fiber 92 that may be disposed within the bore 62 of the ferrule assembly 60. Optical fibers 92 may be any suitable optical fiber for transmitting optical signals and may include multi-mode or single-mode optical fibers, and other suitable optical fibers are possible according to the concepts disclosed. Likewise, optical fiber 92 may have any suitable size for the optical core, cladding or coating. Optical fiber 92 may have a buffer layer to upsize the diameter and/or protect the optical fiber to form the fiber optic cable 90.

Fiber optic cable 90 may also include features such as a cable jacket, strength members, ripcords or the like. By way of example, fiber optic cable 90 could be a two-fiber zipcord having a cable jacket that may be separated for separating the optical fibers 92 into separate legs along a portion of the cable.

Connectors 100, 200 may include other components as desired. By way of explanation, the connectors may further one or more boots 96 for providing bending strain relief and/or aiding in securing the terminated ferrule assembly 60 to the connector housing 140, 240. As shown in FIG. 1, boot 96 may include an attachment feature 97 for securing the boot 96 to the housing 140, 240 by snap-fitting into window 247 formed in the housing once the terminated ferrule assembly 60 is fully-inserted into the passageway 142, 242 of the connector housing 140, 240. Consequently, the terminated ferrule assembly 60 is inhibited from being pulled-out of the connector housing. Further, the boot 96 may include one or more alignment feature 98 such as a rail (i.e., longitudinal protrusion) or the like that cooperates with a cooperating alignment feature on the connector housing such as a slot or the like. The connector 100 may also include an outer housing 150 having a latching trigger 152 for cooperating with structure on the connector housing 240 of connector 200, thereby securing the optical mating between connectors 100, 200 and providing a release that requires depressing of the latching trigger for unmating the connectors 100, 200. The outer housing 150 may also include rails 154 on opposing side of the latching trigger 152 for inhibiting unintentional release of the optical mating between connectors. Other structures are also possible for securing the optical mating of connectors. Further, connector housings 140, 240 may have other structure such as ribs 240, a bridge or the like for protecting the connectors from rough handling or the like.

Connectors may also have other structures or features as desired. For instance, connectors 100, 200 may further include a spring 67 for biasing the ferrule assembly 60 to a forward position for maintain a physical contact between ferrules or the like for mating at the optical interface 68; however, the concepts may be used without the need for a spring. Likewise, connector 200 may include a sleeve 89 for precisely aligning mating ferrule assemblies 60. As shown, sleeve 89 may be disposed in the passageway 242 of connector 200, and each ferrule assembly 60 of the connector has a dedicated sleeve 89.

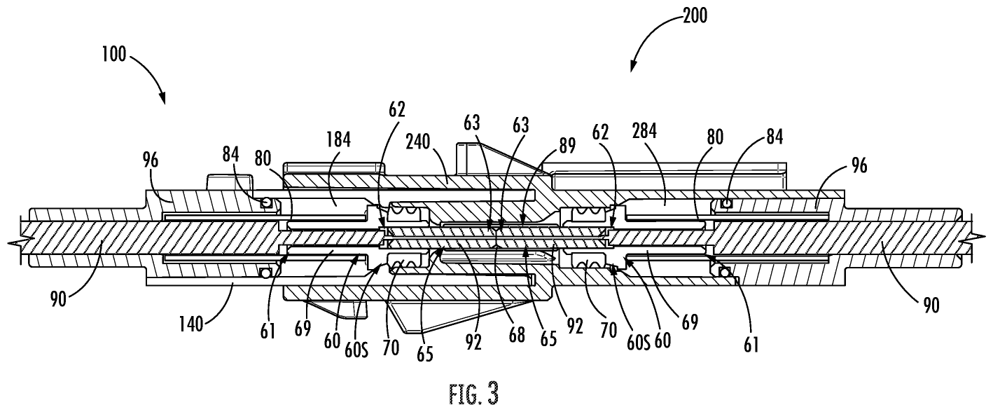

The disclosed connectors may further include supplemental sealing if desired. FIG. 3 depicts another optical mating of connectors 100, 200 that are similar to the connectors 100, 200 of FIGS. 1 and 2, and further includes a secondary seal 84. As depicted, the secondary seal 84 is disposed rearward of the sealing gasket 70 for the connectors. As shown, the secondary seal 84 is disposed on an outer surface of the respective boot 96, thereby providing respective secondary sealing cavities 184, 284 within the passageways 142, 242 of the respective connector housings 140, 240. The secondary seal 84 may be formed by any suitable component such as an O-ring or other structure or feature as desired. In this embodiment, the forward portion of the boot 96 comprises a suitable sized groove for seating the O-ring and providing the secondary sealing cavity with the inner wall of the connector housings 140, 240.

As best shown in FIG. 4, ferrule assembly 60 comprises a rearward portion 61 and a forward portion 63. A shoulder 60S may be disposed between the rearward portion 61 and the forward portion 63 of the ferrule assembly 60, and the sealing gasket 70 is disposed on the forward portion 63 of the ferrule assembly 60. The shoulder 60S allows the sealing gasket 70 to be compressed when the connector 100, 200 is mated for creating the sealing cavity (SC). FIG. 4 depicts the sealing cavity (SC) within the passageway 242 of the connector housing 240 between the respective sealing gaskets 70 as represented by the cross-hatched portion (i.e., the area between the respective scaling gaskets).

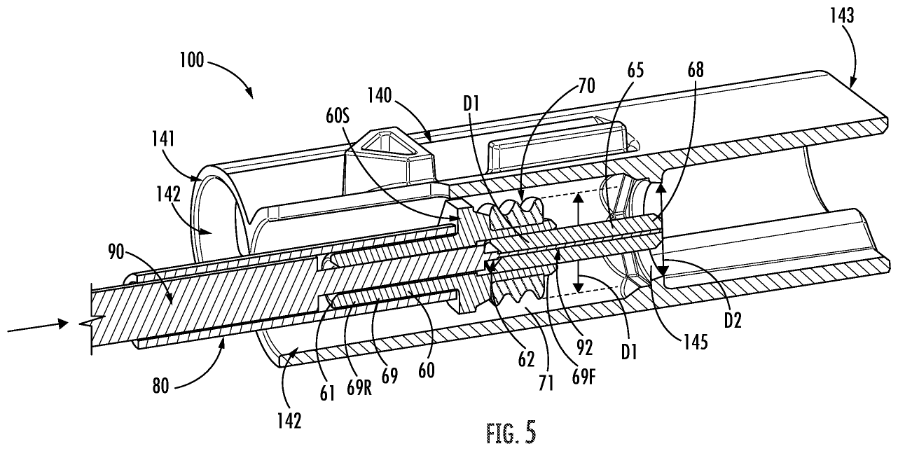

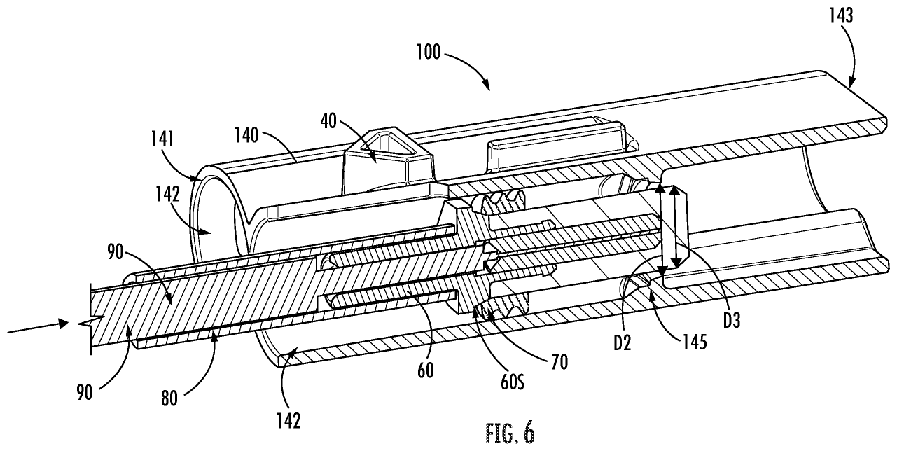

FIGS. 5 and 6 depict sectionals view of connector 100 for showing features that may be used with the connector concepts disclosed. FIG. 5 depicts the insertion of the ferrule assembly 60 terminated to the fiber optic cable 90 as represented by the arrow at the rear of the fiber optic cable 90. The ferrule assembly 60 may be strain-relieved to the fiber optic cable 90 using a crimp sleeve 80 such as a brass sleeve or the like. The crimp sleeve 80 may be slid onto the fiber optic cable 90 and the optical fiber 92 is inserted within the bore 62 of the ferrule assembly 60. As depicted, the crimp sleeve 80 is sized to fit over a rear end 61 of the ferrule assembly 60 and fit over a front portion of the fiber optic cable 90. The crimp sleeve 80 may slid forward on the fiber optic cable 90 to position the crimp sleeve 80 about the rear end 61 of the ferrule assembly 60 and the front portion of the fiber optic cable. Thereafter, the crimp sleeve 80 may be deformed about the front portion of the fiber optic cable 90 and deformed about the rear portion of the ferrule assembly 60 for securing the ferrule assembly 60 to the fiber optic cable 90. Polishing of the ferrule assembly, inspection or other assembly steps may be performed as desired. The sealing gasket 70 may be positioned about a forward portion of the ferrule assembly 60 forward of the shoulder 60S as depicted. The fiber optic cable 90 terminated with the ferrule assembly 60 may be inserted into the rear end 141, 241 of passageway 142, 242 of the connector housing 140, 240 so that the ferrule assembly is at least partially disposed within the passageway 142, 242. The sealing gasket 70 may have a diameter D1 that is slightly larger than a diameter D2 of the opening of the housing at the internal wall 145 as depicted. The rear side of the opening at the internal wall 145 may have a tapered surface if desired.

Ferrule assembly 60 may have any suitable optical interface 68 desired. By way of explanation, the connectors 100, 200 disclosed may have an optical interface 68 allows optical mating using physical contact or free-space coupling using a lens for the disclosed connectors. Lens-based configurations of connectors may also have the mating interface 68 in physical contact if desired. The ferrule assembly 60 of FIG. 5 is configured for physical contact and comprises a ferrule 65 at least partially disposed in a ferrule holder 69 as depicted. In this configuration, the ferrule holder 69 comprises a forward portion 69F and a rearward portion 69R with shoulder 60S disposed between the forward portion 60F and the rearward portion 69R with the ferrule 65 attached to the ferrule holder 69 to form the ferrule assembly 60. Thus, the bore 62 for the physical contact (PC) configurations extend from the rear end to the front end of the ferrule assembly 60 so the optical fiber 92 may extend to the optical interface 68 at the front end of the ferrule assembly 60 for optical mating with a complimentary mating optical fiber/ferrule assembly.

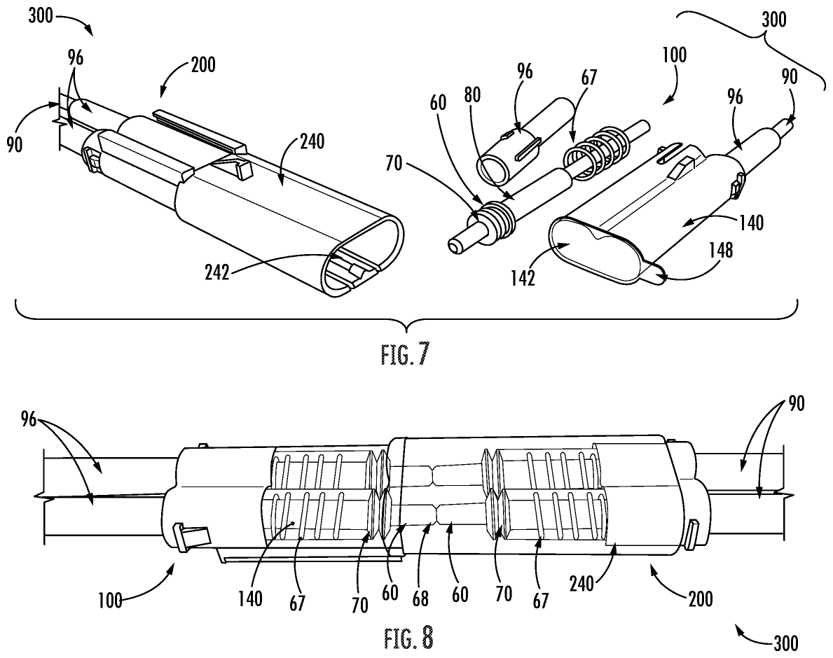

Alternatively, optical interface 68 of the ferrule assembly 60 for connectors 100, 200 may comprises a lens such as depicted in FIG. 7. If the ferrule assembly 60 has an optical interface configured as a lens the ferrule assembly 60 may be formed by a single component suitable for transmitting optical signals through the material of the ferrule assembly. In other lens-based configurations, the ferrule assembly 60 may comprise a suitable lens component disposed at the optical interface 68 of the ferrule assembly 60. In other words, the ferrule assembly 60 may have a lens molded-in as part of the ferrule assembly 60 or a separate lens may be attached at the end of the ferrule assembly 60. If ferrule assembly 60 is a lens-based configuration, then the bore 62 typically stops short of the optical interface 68 of the ferrule assembly 60 and the optical fiber 92 cooperates with the lens. If the optical interface 68 comprises a lens, the connector can be used without a spring. Fiber optic connectors 100, 200 may also use multi-fiber ferrules assemblies 60 if desired.

Scaling gasket 70 may be formed from any suitable material and is preferably selected from a material that is compatible with the material of the connector and provides the desired performance over the intended operating parameters such as temperature, reliability and longevity. Sealing gasket 70 may comprises a silicone, a polybutylene terephthalate (PBT), a polymer material or a rubber material, but other suitable materials are possible. By way of explanation, a silicone material may be useful since it remains stable and pliable over a wide temperature range and/or compression forces. Additionally, the sealing gasket 70 is appropriately sized for providing the desired performance for sealing, compression, etc. Sealing gasket 70 may include one or more ridges 71 (i.e., one or more glands) for the desired performance. As shown, scaling gasket 70 has three ridges 71, but other suitable geometries are possible for the scaling gasket 70.

FIG. 6 is a sectional view of connector 100 showing the ferrule assembly 60 terminated to the fiber optic cable 90 and being inserted into connector housing 140 from the rear end 141 similar to FIG. 5. FIG. 6 further depicts a dust cap (not numbered) disposed on the ferrule assembly 60 being inserted into a passageway 142 of the connector housing 140. The dust cap protects the optical interface 68 before the connector is mated to another suitable device and protected from moisture, dust, dirt, debris or the like. The dust cap comprises a suitable diameter D3 for passage through the opening with diameter D2 in internal wall 145 of housing 140.

FIG. 7 depicts another configuration of connectors 100, 200 configured as a male plug and female receptacle with ferrule assemblies 60 with sealing gasket 70 as portions of cable assemblies 300 similar to the connectors of FIGS. 1 and 2. In this configuration, the optical interface 68 of ferrule assemblies 60 comprise lenses. As shown, ferrule assemblies 60 are molded as a single component using an optically transparent material for the desired optical wavelengths for optical communication. FIG. 7 shows the fiber optic connector 100 further comprising a sealing membrane 148 attached to the front end of the connector housing 140 for keeping the ferrule assembly clean from dust, dirt, debris or the like prior to optical mating. Sealing membrane 148 is disposed on the front end about a perimeter of the connector housing 140 for inhibiting contaminants from reaching the optical interface 68 of the respective ferrule assemblies 60. The sealing membrane 148 may be removed from the connector housing 140 for optical mating when desired. Sealing membrane 148 may be used with or without a dust cap on the ferrule assembly 60 as desired. FIG. 8 depicts the connectors similar to FIG. 7 in a mated state and shown with transparent housings so that the construction of connectors 100, 200 are visible.

Any of the fiber optic connector 100, 200 disclosed may be a portion of a cable assembly 300 having one or more cables 90 terminated to the respective connectors 100, 300. Further, the connectors 100, 200 or cable assemblies 300 disclosed may be used in any desired application. By way of example, the cable assemblies 300 may be a portion of a vehicle such as an automobile or the like.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. A fiber optic connector comprising:
at least one ferrule assembly comprising a bore extending from a rear end into the at least one ferrule assembly, and an optical interface disposed at a front end of the ferrule assembly;
an optical fiber disposed within the bore of the ferrule assembly;
a connector housing comprising a passageway extending from a rear end to a front end, wherein the ferrule assembly is at least partially disposed within the passageway; and
a sealing gasket disposed about a portion of the ferrule assembly for inhibiting contaminants from reaching the optical interface of the ferrule assembly when the fiber optic connector is mated.

2. The fiber optic connector of claim 1, wherein ferrule assembly comprises a forward portion and a rearward portion with a shoulder disposed between the forward portion and the rearward portion, and wherein the sealing gasket is disposed on the forward portion of the ferrule assembly.

3. The fiber optic connector of claim 1, wherein the sealing gasket comprises a silicone, a polybutylene terephthalate (PBT), a polymer material or a rubber material.

4. The fiber optic connector of claim 1, wherein the sealing gasket is compressed when the fiber optic connector is mated.

5. The fiber optic connector of claim 1, wherein the sealing gasket comprises one or more ridges.

6. The fiber optic connector of claim 1, further comprising a second ferrule assembly with a second sealing gasket disposed on the second ferrule assembly received within a second passageway.

7. The fiber optic connector of claim 1, further comprising a secondary seal disposed rearward of the sealing gasket.

8. The fiber optic connector of claim 1, wherein the optical interface comprises a lens.

9. The fiber optic connector of claim 1, wherein the at least one ferrule assembly comprises a ferrule that defines the optical interface and is configured for optically mating using physical contact.

10. The fiber optic connector of claim 1, wherein the fiber optic connector is configured as a male plug, a female receptacle or a connector port.

11. The fiber optic connector of claim 1, wherein the sealing gasket is disposed within the passageway of the connector housing.

12. The fiber optic connector of claim 1, wherein the fiber optic connector is a portion of a cable assembly.

13. The fiber optic connector of claim 1, wherein the fiber optic connector is a portion of a cable assembly of a vehicle.

14. A fiber optic connector comprising:
a ferrule comprising a bore extending from a rear end into the ferrule, and an optical interface disposed at a front end of the ferrule;
a ferrule holder comprising a forward portion and a rearward portion with a shoulder disposed between the forward portion and the rearward portion, and wherein the ferrule is attached to the ferrule holder to form a ferrule assembly;
an optical fiber disposed within the bore of the ferrule;
a connector housing comprising a passageway extending from a rear end to a front end, wherein the ferrule assembly is at least partially disposed within the passageway; and
a sealing gasket disposed about the forward portion of the ferrule holder for inhibiting contaminants from reaching the optical interface of the ferrule when the fiber optic connector is mated.

15. The fiber optic connector of claim 14, wherein the sealing gasket comprises a silicone, a polybutylene terephthalate (PBT), a polymer material or a rubber material.

16. The fiber optic connector of claim 14, wherein the sealing gasket is compressed when the fiber optic connector is mated.

17. The fiber optic connector of claim 14, wherein the sealing gasket comprises one or more ridges.

18. The fiber optic connector of claim 14, further comprising a second ferrule assembly with a second sealing gasket disposed on the second ferrule assembly received within a second passageway.

19. The fiber optic connector of claim 14, further comprising a secondary seal disposed rearward of the sealing gasket.

20. The fiber optic connector of claim 14, wherein the optical interface comprises a lens.

21. The fiber optic connector of claim 14, wherein the at least one ferrule assembly comprises a ferrule that defines the optical interface and is configured for optically mating using physical contact.

22. The fiber optic connector of claim 14, wherein the fiber optic connector is configured as a male plug, a female receptacle or a connector port.

23. The fiber optic connector of claim 14, wherein the sealing gasket is disposed within the passageway of the connector housing.

24. The fiber optic connector of claim 14, wherein the fiber optic connector is a portion of a cable assembly.

25. The fiber optic connector of claim 14, wherein the fiber optic connector is a portion of a cable assembly of a vehicle.

26. A method of making a fiber optic connector comprising:
assembling a ferrule into a ferrule holder to form a ferrule assembly, wherein the ferrule comprises a bore extending from a rear end into the ferrule, and an optical interface disposed at a front end of the ferrule;
positioning a sealing gasket about a portion of the ferrule assembly for inhibiting contaminants from reaching the optical interface of the ferrule when the fiber optic connector is mated;
inserting the ferrule assembly into a passageway of a connector housing that extends from a rear end to a front end of the connector housing so that the ferrule assembly is at least partially disposed within the passageway; and
placing an optical fiber within the bore of the ferrule.

27. The method of claim 26, wherein ferrule holder comprises a forward portion and a rearward portion with a shoulder disposed between the forward portion and the rearward portion of the ferrule holder, and wherein the sealing gasket is positioned on the forward portion of the ferrule holder.

28. The method of claim 26, wherein the sealing gasket comprises one or more ridges.

29. The method of claim 26, further comprising the step of forming a second ferrule assembly and positioning a second sealing gasket on the second ferrule assembly, and inserting the second ferrule assembly into the passageway of the connector housing so that the second ferrule assembly is at least partially disposed within the passageway of the connector housing.

30. The method of claim 26, further comprising positioning a secondary seal disposed rearward of the sealing gasket.

31. The method of claim 26, wherein the optical interface comprises a lens or is defined by one or more ferrules that optically mate using physical contact.

32. The method of claim 26, wherein the fiber optic connector is configured as a male plug, a female receptacle or a connector port.

33. The method of claim 26, wherein the sealing gasket is disposed within the passageway of the connector housing.

34. The method of claim 26, wherein the fiber optic connector is a portion of a cable assembly.

35. The method of claim 26, wherein the fiber optic connector is a portion of a cable assembly of a vehicle.
